(19) United States
(12) Patent Application Publication
(10) Pub. No.: US 2014/0365622 A1
(43) Pub. Date: Dec. 11, 2014

(54) SOFTWARE DEFINED NETWORKING FOR STORAGE AREA NETWORKS

(71) Applicant: CISCO TECHNOLOGY, INC., San Jose, CA (US)

(72) Inventors: Sampath Magesh Iyengar, BANGALORE (IN); Ashish Dalela, BANGALORE (IN); Murali K. Basavaiah, Sunnyvale, CA (US)

(73) Assignee: CISCO TECHNOLOGY, INC., San Jose, CA (US)

(21) Appl. No.: 13/912,030

(22) Filed: Jun. 6, 2013

(51) Int. Cl. H04L 12/24; H04L 29/08

(52) U.S. Cl. CPC H04L 41/0803; H04L 67/1097
USPC 709/220

(57) ABSTRACT

An example method for facilitating software defined networking for storage area networks is provided and includes dividing a control plane of a storage area network (SAN) into a centralized network control plane and a plurality of decentralized control planes, configuring network-wide SAN applications in the centralized network control plane, and configuring switch-level SAN applications in the decentralized control planes. In a specific embodiment, the network-wide SAN applications include at least one selection from a group consisting of: name server, zone server, worldwide name-virtual SAN (VSAN) mapping, device aliases, link-state routing information, principal switch selection, domain manager, and virtual local area network-VSAN mapping.

### TECHNICAL FIELD

This disclosure relates in general to the field of communications and, more particularly, to software defined networking (SDN) for storage area networks (SANs).

### BACKGROUND

A storage area network (SAN) can transfer data between computer systems and storage elements through a specialized high-speed network. In general, the SAN can enable the storage devices to be accessible to servers so that the storage devices appear like locally attached devices to the servers' operating systems. The SAN consists of a communication infrastructure, which provides physical connections. The SAN facilitates the flexibility of networking to enable one server or many heterogeneous servers to share a common set of storage devices. The SAN typically has its own network of storage devices, including disks, tapes, and optical storage that are generally not accessible through a local area network by other devices. The SAN also includes a management layer, which organizes the connections, storage devices, and computer systems so that data transfer is secure and robust. The SAN allows any-to-any connection across the network by using interconnect elements such as switches.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system facilitating SDN for SANs;

FIG. 2 is a simplified block diagram illustrating example details of the communication system in accordance with one embodiment;

FIG. 3 is a simplified block diagram illustrating other example details of the communication system in accordance with one embodiment;

FIG. 4 is a simplified block diagram illustrating yet other example details of the communication system in accordance with one embodiment;

FIG. 5 is a simplified block diagram illustrating further example details of an embodiment of the communication system;

FIG. 6 is a simplified block diagram illustrating further example details of an embodiment of the communication system;

FIG. 7 is a simplified block diagram illustrating further example details of an embodiment of the communication system;

FIG. 8 is a simplified block diagram illustrating further example details of an embodiment of the communication system;

FIG. 9 is a simplified block diagram illustrating further example details of an embodiment of the communication system;

FIG. 10 is a simplified flow diagram illustrating example operational activities that may be associated with embodiments of communication system; and

FIG. 11 is a simplified flow diagram illustrating other example operational activities that may be associated with embodiments of communication system.

### DETAILED DESCRIPTION OF EXAMPLE EMBODIMENTS

### Overview

An example method for facilitating SDN for SANs is provided and includes dividing a control plane of a SAN into a centralized network control plane and a plurality of decentralized control planes, configuring network-wide SAN applications in the centralized network control plane, and configuring switch-level SAN applications in the decentralized control planes. In a specific embodiment, the network-wide SAN applications include name server, zone server, worldwide name-virtual SAN (VSAN) mapping, device aliases, link-state routing information, principal switch selection, domain manager, and/or virtual local area network-VSAN mapping. In some embodiments, the decentralized control planes include switch control planes; in other embodiments, the decentralized control planes include switch control planes and line card control planes.

### Example Embodiments

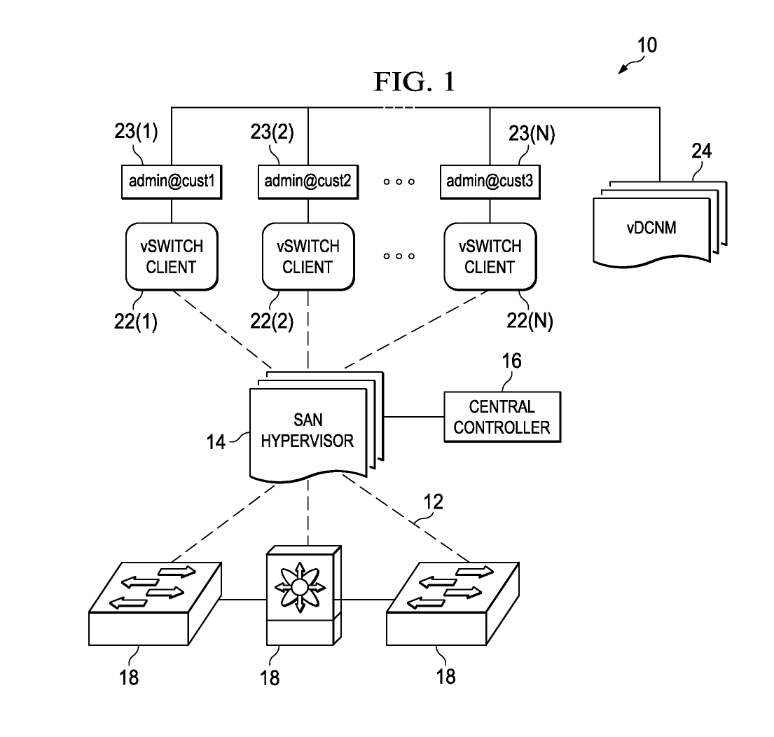

Turning to FIG. 1, FIG. 1 is a simplified block diagram illustrating an embodiment of communication system 10 that facilitates software defined networking in storage area networks. Communication system 10 includes a SAN 12 (generally indicated by an arrow) comprising a SAN hypervisor 14 including a central controller 16. SAN hypervisor 14 may connect various network elements 18 with one or more clients, called vSwitch Clients 22(1)-22(N) controlled by corresponding administrators 23(1)-23(N). vSwitch Clients 22(1)-22(N) may be managed by a manager, such as a virtual data center network manager (vDCNM) 24.

As used herein, the term “network element” can include computers, network appliances, servers, routers, switches, gateways, bridges, load balancers, firewalls, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

According to various embodiments, SAN protocols may be abstracted into central controller 16 along with distributed (or centralized) local area network (LAN) protocols. Certain network-wide SAN applications can be centralized through central controller 16, while certain other switch-level SAN applications can be decentralized from central controller 16 in some embodiments allowing for differentiated centralization. As used herein, the term “network-wide SAN applications” include interfaces, services, and routing protocols that rely on knowledge of the entire network topology, or that are independent of any network topology to function appropriately. To illustrate with an example, any application that relies on data that is the same when computed or accessed anywhere in the network, can be classified as a network-wide SAN application. Examples of network-wide SAN applications include name servers and zone servers.

On the other hand, “switch-level SAN applications” include link-level applications, switch-level SAN services, interfaces, and routing protocols that rely on knowledge of a portion (e.g., at a link-level or at a switch-level) of the network topology, rather than the entire network topology, to function appropriately. For example, link-level information, such as peer-to-peer connectivity, can affect packet processing performance by the switch-level SAN applications. If data computed or accessed by the application can change from point to point within the network, the application may be categorized as a switch-level SAN application. Examples of switch-level SAN applications include Fabric Login (FLOGI), Routing Information Base (RIB), Access Control Lists (ACLS), and Fabric Shortest Path First (FSPF) Hello. For example, switches in SAN 12 may implement routing applications such as FSPF Hello by computing the “next hop” routing segment for a packet having a particular source-destination pair. The combined next hop computations of the various switches in SAN 12 can result in an end-to-end route being defined for each source-destination pair through multiple switches.

Differentiated centralization can allow virtualization of SAN 12, allowing different SAN administrators 23(1)-23(N) to control their distinct networks in a virtual manner. Central controller 16 can enable separating control plane functions from forwarding plane functions in some embodiments. In other embodiments, certain SAN applications may be centralized, whereas certain other SAN applications may be decentralized.

For purposes of illustrating the techniques of communication system 10, it is important to understand the communications that may be traversing the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Data stored in disparate datacenters is constantly growing, needing larger amount of storage resources. At the same time, datacenter operators want to consolidate many small datacenters into a few large datacenters. SAN consolidation can present a level of complexity and scaling that are beyond the capabilities of current SAN products, which are typically implemented according to distributed models. For example, cloud based SANs may include multi-tenant architecture, with different customers renting storage space on the cloud based SANs. Customers can include different departments in the same company, or they can include different companies.

A typical SAN facilitates direct, high-speed data transfers between servers and storage devices, potentially in any of the following three ways: server to storage, where the same storage device is accessed serially or concurrently by multiple servers; server to server: where the SAN facilitates high-speed, high-volume communication between servers; storage to storage providing outboard data movement capability that enables data to be moved without server intervention, thus freeing up server processor cycles for other activities like application processing (e.g., a disk device that backs up its data to a tape device without server intervention, or a remote device mirroring across the SAN.

SANs may rely on various suitable communication protocols to communicate data in a lossless manner from and to storage devices. For example, SANs may use Fibre Channel (FC), which is a high-speed network technology (commonly running at 2-, 4-, 8-, and 16-gigabit speeds). FC includes a topology where devices are connected to FC switches. FC traffic generally requires a lossless transport layer because losing a single data packet in the data storage context may be unacceptable. Another example protocol used in SAN is FCoE. FCoE enables convergence of the LAN, which typically uses Ethernet protocol, and SAN, with an overlay of FC based SANs over a lossless Ethernet infrastructure of the LAN, removing the need for native FC switches or directors (FC fabric). Equipment, installation, and operational costs are significantly reduced in the converged environment and the resulting decrease in network complexity provides a corresponding increase in network reliability.

The FCoE protocol is generally defined by American National Standards Institute (ANSI) International Committee for Information Technology Standards (INCITS) FC-BB-5 and FC-BB-6. The FC traffic encapsulated inside Ethernet uses the same lossless network characteristics that are found in a fabric network. Instead of a buffer-to-buffer (B2B) credit system used in native fabric topologies, FCoE may rely on Ethernet protocols and related standards that ensure lossless transport of the FCoE traffic.

Typically, FCoE uses virtual FC interfaces and a small set of control plane functions to build virtual links (e.g., a link is a communications channel that connects two or more nodes; the link may be generally an actual physical link or it may be a logical (e.g., virtual) link that uses one or more actual physical links) among pairs of virtual FC interfaces. Multiple virtual FC interfaces can be presented on the same physical Ethernet interface of an FCoE Forwarder (FCF). After the virtual links are established among pairs of virtual FC interfaces, the result is presented to the FC stack as a set of point-to-point connections that behave like regular FC connections, regardless of the number of FCoE pass-through switches that are physically inserted between the actual FC endpoints. FCoE technology uses FCoE Initialization Protocol (FIP) Discovery comprising control plane functions to enable discovery of FCoE-capable devices across FCoE pass-through switches and establishment of appropriate combinations of virtual links.

Further, various message protocols may be used between processes executing in the SAN, with corresponding message brokers. For example, the message and transaction service (MTS) is a high-performance inter-process communications (IPC) message broker that specializes in high-availability semantics. MTS handles message routing and queuing between services on and across modules and between managing processors (e.g., supervisors, controllers, etc.). MTS facilitates the exchange of messages such as event notification, synchronization, and message persistency between services and components. MTS can maintain persistent messages and logged messages in queues for access even after a service restart.

SANs typically support various SAN applications such as Zoning Database, Name Server database, Access Control Lists (ACLS), and FLOGI, to name a few. For example, the zone server maintains a database of zones in the SAN. When a fabric (e.g., switching element that permits any-to-any switching within a switch) is first started, every switch connected to the fabric can establish a connection with any other switch connected to the fabric. Zoning provides a means of restricting visibility and connectivity between devices connected to a common FC SAN. Substantially all the devices configured in a specific “zone” can communicate with each other. The rest of the devices connected to the zone that are not included in the zone are not visible by the ones inside and vice versa. Zoning is typically hardware-enforced at the FC switches. The zoning service is implemented as a distributed service within a FC SAN. A distributed database called the zoning database is synchronized and maintained within all member switches of the SAN. As a distributed service, the zoning database can be updated by any member switch of the fabric.

In another example, when a host server logs into a fabric, the login information may be stored locally at the switch in a FLOGI database. The switch may also distribute the host login information to other switches in the network. Each switch in the network may build a separate FLOGI database based on the aggregated information received from substantially all switches in the network. In yet another example, ACLs may also distribute access restrictions, which can be aggregated into separate databases across the network. Such information may be replicated across the different switches in the network. The replication can be potentially error prone and can cause scaling problems.

Turning to link-state routing protocols, link-state routing protocols are known to have scaling problems as the network grows larger. The scaling problems arise because each switch (e.g., network element that connects network segments) builds up a link-state database for the entire network. To build the link-state database, each switch in the network exchanges information about its peer-to-peer connectivity. If the network includes N switches each connected to M peers, there are N×M links in the network (from the perspective of each switch). Each switch builds a database of N×M links and keeps the database updated. Thus, there are N copies of N×M link-states. As the number of switches N becomes large and topologies change (potentially changing the peer-to-peer connectivity), synchronizing the N copies of N×M link-states can be challenging. In SANs, the link-state database scaling and synchronization problem can be worsened by the VSANs in the fabric. If each switch has P VSANs allowed over each of the M links, then the link-state database has N×M×P entries at each of the N switches.

The problem is further compounded because the SAN switches store information about servers and storage devices in addition to switches. The stored information includes link-state databases (e.g., which reflect network connectivity), host information discovered during login, zones, host-aliases, World Wide Name (WWN) to VSAN mapping (e.g., which reflect host connectivity and configuration). To keep this information identical across the fabric, network protocols—standard or proprietary—are used to replicate the data between the SAN switches.

For example, name-server and link-state synchronization can be implemented through standard protocols; device aliasing and WWN-VSAN mappings can be synchronized through proprietary protocols. Synchronization can take up a substantial amount of network bandwidth, processing time, and other overhead, which can be burdensome on the network as the network enlarges, especially if multiple identical copies of the same information have to be maintained in disparate locations (e.g., switches) throughout the network.

One way to enable scaling in SANs is through virtualization. SAN virtualization typically faces two types of problems: domain-identifier (ID) scaling, and virtual SAN (VSAN) scaling. According to FC standards, the SAN fabric can operate without loops using distinct domains with corresponding domain-IDs. Switches may be identified by the respective domain-IDs. However, FC standards mandate a maximum of 239 possible domains with corresponding domain-IDs, which can be restrictive of the total size of the SAN. For example, with 239 possible domain-IDs, only 239 switches can be configured in the SAN. Although the domain-ID permits each of the 239 switches to accommodate 65535 hosts to a switch, it is physically impossible to attach as many switches to a switch due to technology limitations. For example, only 500 hosts can be connected to a switch (on a higher end). Therefore, most of the address space in the SAN may be wasted.

VSAN identifies a virtual fabric with the ability to create completely isolated fabric topologies, each with its own set of fabric services, on top of a scalable common physical infrastructure. Zoning is then configured within each VSAN independently. A total of 4096 VSANs can be implemented in a specific SAN according to applicable standards (e.g., VSAN has a 12 bit VSAN-ID). Theoretically, 4096 tenants may be deployed in the SAN, with each tenant assigned a separate VSAN-ID. However, in a practical sense, each tenant in the SAN may use multiple VSANs, restricting the maximum number of tenants in the SAN that can be assigned separate VSAN-IDs. In case of FCoE, the number of available VSANs may be further restricted because the VSANs can be segregated across Ethernet and storage traffic and a fewer number of VSANs may be available for FCoE traffic.

Another way to enable scaling is to implement software defined networking (SDN) in SANs. A known mechanism that implements SDN includes a central controller in a virtual machine that can support a software defined storage network by applying certain predefined rules and actions to enable the FC and FCoE nodes to communicate with each other. The central controller may not have any switching, bridging, or forwarding capabilities similar to the functions inherent in the FCF.

However, centralization is not without its disadvantages. For example, switches in the SAN exchange frequent hello packets to keep the Fabric Shortest Path First (FSPF) links alive. FCoE hosts and targets periodically exchange Link Layer Discovery Protocol (LLDP) and FCoE Initialization Protocol (FIP) frames to keep the FCoE links alive. Indiscriminate centralization can cause delays in information that is periodically and frequently exchanged between the switches in the SAN. Delays in exchange of such information can cause links to be reset, forcing many more packets and messages to be exchanged, resulting in a deluge.

Moreover, with increasing port densities (e.g., using Fabric Extenders) periodic packet exchanges (such as LLDP) are being moved to the edge rather than the center of the network. Processing of Bridge Protocol Data Unit (BPDU) frames or Open Shortest Path First (OSPF) hellos are being offloaded closer to the network port, rather than keeping them in the central control plane. The processing capacity can be inadequate for centralized network control planes.

Communication system 10 is configured to address these issues (and others) in offering a system and method for facilitating software defined networking in storage area networks. Embodiments of communication system 10 may include SDN mechanisms to divide a control plane of SAN 12 into a centralized network control plane and a plurality of decentralized control planes. As used herein, the term “control plane” refers to a logical division of network architecture, such as SAN 12, that carries signaling and management traffic (as opposed to the network user's data traffic). The control plane is responsible for routing decisions (e.g., based on the network topology), which are implemented by the data plane. As used herein, the term “data plane” includes another logical division of network architecture, such as SAN 12, that carries network user data traffic. Control plane functions typically include monitoring network throughput and performance, updating the network topology, establishing new connections, and enforcing security and service policies.

In a specific embodiment, certain system-wide databases may be centralized, and certain switch-level packet processing may be decentralized. The centralized network control plane can be configured with network-wide SAN applications. The plurality of decentralized control planes can be configured with switch-level SAN applications. In a specific embodiment, the centralized network control plane may be implemented on central controller 16 according to SDN architecture. The decentralized control planes may be implemented in a distributed manner on switches, or line cards, or a combination of both switches and line cards, in SAN 12.

The network-wide SAN applications include, by way of examples and not as limitations, name server, zone server, WWN-VSAN mapping, device aliases, link-state routing information, principal switch selection, domain manager, and VLAN-VSAN mapping. Various other system-wide databases may also be centralized within the broad scope of the embodiments. In some embodiments, the decentralized control planes include switch control planes. The switch-level SAN applications provided by the switch control planes include by way of examples and not as limitations, LLDP, CDP, FIP, FLOGI, ACLs, platform management, routing information base (RIB), and FSPF Hello.

In other embodiments, the decentralized control planes include switch control planes and line card control planes. The switch-level SAN applications provided by the switch control planes include, by way of examples and not as limitations, ACLs, RIB and platform management. The switch-level SAN applications provided by the line card control planes include, by way of examples, and not as limitations, LLDP, CDP, FIP, FLOGI, and FSPF Hello. Various other switch-level packet processing may be decentralized within the broad scope of the embodiments.

According to various embodiments, SAN 12 can include a plurality of domains, with a plurality of switches belonging to any particular domain. In some embodiments, each switch can belong to at most one domain, and have a corresponding domain ID assigned thereto. In other embodiments, each switch can belong to more than one domain. In such embodiments, SAN 12 can include a plurality of line cards, and the domain ID can be assigned to each line card. In some specific embodiments, a contiguous set of domain IDs may be assigned to line cards in a single domain. In various embodiments, a unique FC ID may be assigned to each end device configured within a VSAN. In such embodiments, each domain can span a plurality of switches.

SDN can facilitate centralization of the control plane as a mechanism to consolidate complex logic into a central location represented by central controller 16. In some embodiments, SDN for SAN can leverage substantially all the LAN protocols for switch-to-switch and host-to-switch connectivity, including LLDP/CDP, TCP/IP routing, allowing the SAN applications such as Name Server, Zone Server, WWN-VSAN mapping, Device Aliasing, Principal Switch Selection, etc. to be hosted out of central controller 16, if and as needed. Central controller 16 can also be virtualized for certain functions like Zone and Name Server, Device Aliasing, WWN-VSAN mappings, etc. Thus, a single virtual instance of SAN 12 can be controlled by a distinct SAN admin (e.g., admin@cust1 23(1)).

In some embodiments, some SAN protocols can be abstracted into central controller 16 and other SAN protocols and LAN protocols can be executed in a distributed manner. The centralization may not necessitate any changes to SAN standards, including protocols and interfaces. For example, substantially all currently defined protocols between servers, storage devices, and switches can be used as currently defined, without major changes. Some protocols such as FSPF (e.g., link state advertisement (LSA) exchanges used for setting up domain-to-domain routes), Domain Merge (e.g., for switch-to-switch discovery of servers and storage devices), Principal Switch Selection (e.g., for discovery of a principal switch that assigns Domain IDs during restart) may not needed if centralized. By centralizing, a single copy of various network-wide databases can be maintained and scaled suitably. Use of differentiated centralized controller 16 (e.g., that can differentiate between network-wide SAN applications and switch-level SAN applications) can support a highly scalable network without implementing all aspects of the high scale at each switch.

Central controller 16 can also be used to perform global optimizations such as host-to-disk path optimization. For example, servers and storage devices involved in fat flows can be placed closer together; servers and storage devices involved in mouse flows can be placed farther apart. Global optimizations can also include global monitoring of end-to-end flows and provisioning of service level agreements (SLAs) for the flows. Moreover, central controller 16 can be virtualized across multiple tenants. The virtualized per-tenant controllers can be provided to cloud based SAN users for a single point of control for the respective tenant controlled portion of SAN 12. Embodiments of communication system 10 can be implemented in traditional FC based SANs, converged FCoE based SANs, and co-existing FC/FCoE based SANs.

In some embodiments, differentiated centralization of SAN protocols can simplify configuration and virtualization of SAN 12. Differentiated centralization can enable users to write customized applications and manage single points of control for even large and complex networks. The operational simplification can simplify ease of use of these networks and reduce operational costs. From a vendor perspective, differentiated centralization can enable larger SAN networks by amortizing controller scale over a larger number of switches; by not having to implement peak scale requirement at every switch and by over-provisioning to facilitate peak scale needs.

In some embodiments, having a single central location for checking names (e.g., name server) can ease debug and monitoring. A single, consistent network-wide software version and features may be implemented in central controller 16, enable various management efficiencies, including a one time network upgrade, as needed, thereby avoiding several end-device upgrades. Licenses for various SAN applications may be installed at SAN hypervisor 14, and dynamically moved across SAN 12, according to various particular needs. Changes to licensing models, if any, can be implemented seamlessly with central controller 16.

In various embodiments, large-scale network testing may be enabled by attached device stubs (e.g., emulated storage devices and servers) to SAN hypervisor 14. A substantial amount of hypervisor validation can be performed without hardware in place. Stable device interface can be emulated by snooping and replaying MTS messages between the control and data planes in SAN 12. Moreover, testing with device stubs can enable lower cost setup of very large topologies and network scaling, with reconfigurable topologies.

In some embodiments, domains can be carved out by arbitrarily combining FC and FCoE ports into a single domain through appropriate configuration at central controller 16. The network topology may be created at central controller 16 based on configurations of the various domains in SAN 12. In some embodiments, message brokers may be used to communicate between central controller 16 and the distributed switch in SAN 12. The communication between the distributed switch and central controller 16 can rely on MTS over IP with a custom or standard reliability protocol. Centralization of certain protocols allows scaling the fabric processing by a factor of 10× or more simply by increasing the CPU/Memory on central controller 16. Further optimizations between controller and platform are also possible within the broad scope of the embodiments.

Turning to the infrastructure of communication system 10, the network topology can include any number of servers, virtual machines, switches (including distributed virtual switches), routers, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications.

Additionally, any one or more of these elements may be combined or removed from the architecture based on particular configuration needs. Communication system 10 may include a configuration capable of TCP/IP communications for the electronic transmission or reception of data packets in a network. Communication system 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of communication system 10. It should be understood that communication system 10 shown in FIG. 1 is simplified for ease of illustration. Moreover, communication system 10 can include any number of spine switches, leaf switches, and servers, within the broad scope of the present disclosure.

The example network environment may be configured over a physical infrastructure that may include one or more networks and, further, may be configured in any form including, but not limited to, LANs, wireless local area networks (WLANs), VLANs, metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof that can permit lossless data transmission as designated in the SAN. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet). SAN 12 may represent any type of storage network, including enterprise storage networks, cloud storage networks, etc.

In various embodiments, vDCNM 24 may provide a management interface that combines management of both LANs and SANs in a single dashboard, which can enables network and storage administrators to troubleshoot health and performance across various networks. vDCNM 24 can offer visibility into virtualized hosts and storage devices by integrating with hypervisors (such as SAN hypervisor 14) and providing host-tracking capability to manage and diagnose virtual and physical servers and storage devices. For example, vDCNM 24 can provide a view of virtual machine paths through physical network to storage array and to the data store, and can enable viewing performance for every switch hop all the way to individual servers and virtual machines. In some embodiments, central controller 16 may also be managed through vDCNM 24.

Central controller 16 may be an application executing on SAN hypervisor 14 in SAN 12. SAN hypervisor 14 may be implemented as a virtual machine in a suitable server or other computing device within SAN 12. In some embodiments, central controller 16 may be managed through appropriate management interfaces associated with SAN hypervisor 14. vSwitch clients 22(1)-22(N) include virtualized (or physical) servers and storage devices connected to a distributed virtual switch, a physical non-distributed switch, or other network element that is capable of forwarding packets within SAN 12.

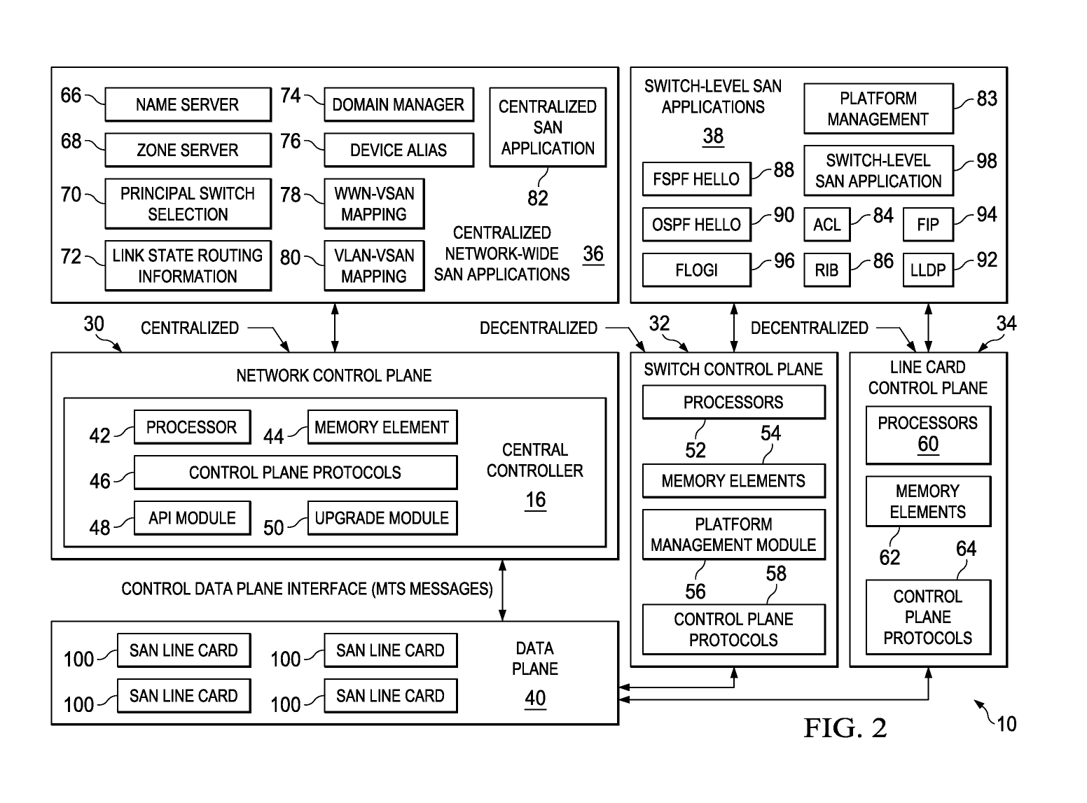

Turning to FIG. 2, FIG. 2 is a simplified block diagram illustrating example details of a logical view of an embodiment of communication system 10. The control plane in SAN 12 may be divided into a network control plane 30, and decentralized control planes, including switch control plane 32 and line card control plane 34. Network control plane 30 may access centralized network-wide SAN applications 36. Switch control plane 32 and line card control plane 34 may access switch-level SAN applications 38. Network control plane 30, switch control plane 32, and line card control plane 34 may provide respective applications to a data plane 40.

Central controller 16 may operate in network control plane 30, and can include a processor 42, and a memory element 33. Central controller 16 may be configured with various suitable control plane protocols 46, API module 48, and an upgrade module 50. API module 48 may facilitate interfacing with data plane 40 based upon particular needs. Upgrade module 50 may provide for updating central controller 16 as desired. Switch control plane 32 may be implemented in the distributed switch of SAN 12 and can include processors 52, memory element 54, a platform management module 56, and various suitable control plane protocols 58. In embodiments that do not include a distributed switch, switch control plane 32 may be implemented in the different switches within SAN 12. Line card level control plane 34 can be implemented in each line card within SAN 12, and can include processors 60, memory elements 62, and suitable control plane protocols 64. As used herein, the term “switch” refers to a network element that can receive packets at various ports, examine the packet headers to determine a source and a destination of the respective packets, and forward the packets to their corresponding destinations. The term “line card” refers to a component within the switch that is configured to receive packets and forward them to appropriate ports in the switch.

Centralized network-wide SAN applications 36 can include, as examples and not as limitations, name server 66, zone server 68, principal switch selection 70, link state routing information 72, domain manager 74, device alias 76, WWN-VSAN mapping 78, VLAN-VSAN mapping 80, and other centralized SAN applications 82. Switch-level SAN applications 38 can include, as examples and not as limitations, platform management 83, ACL 84, RIB 86, FSPF Hello 88, OSPF Hello 90, LLDP 92, FIP 94, FLOGI 96, and other switch-level SAN applications 98. In various embodiments, platform management 83 can include services provided to the respective switches in which the application is configured. The services in platform management 83 can include management of chassis, fans, power supplies, etc.

Domain manager 74 may assign domains to substantially all switches (including any distributed switch) in SAN 12 through central controller 16, negating use of protocols for Principal Switch Selection and Domain Assignment. Central controller 16 can compute substantially all link-state information and push routes into a distributed RIB (e.g., RIB 86). Central controller 16 may maintain a network-wide topology. With centralized name server 66, name server synchronization across switches may not be needed. As any specific server or storage device logs in to the fabric (e.g., performs a port login (PLOGI)), name server attributes are updated centrally in name server 66. Likewise, zone server 68 may be centralized. As each server or storage device logs in, zone server 68 may be notified by the FLOGI process and zone server 68 may push hardware programming into specific switches as configured.

Device alias 76 can store user-friendly names of servers and storage devices in SAN 12 and may be also be used to zone the servers and storage devices. Centrally stored device alias 76 can eliminate any need for multiple synchronized copies throughout SAN 12. WWN-VSAN mapping 78 can facilitate dynamic port-VSAN assignment from a central location, rather than from multiple duplicate copies located at various switches in SAN 12. In many embodiments, as a server or storage device logs into SAN 12, a FLOGI process may query the VSAN configurations stored centrally. In case of FCoE SANs, VLAN-VSAN mapping 80 may be utilized. In many embodiments, VSAN and VLAN management can be centralized, which potentially simplifies the configuration from an operational standpoint, and facilitates Domain ID assignment to servers and storage devices.

One or more SAN line cards 100 may perform packet forwarding in data plane 40. In various embodiments, SAN line cards 100 may communicate with network control plane 30, switch control plane 32 and line card control plane 34 using MTS messages. Centralized, network-wide applications and protocols may be accessed through network control plane 30. Switch-level SAN applications may be accessed through the decentralized control planes, including switch control plane 32 and line card control plane 34. In some embodiments, data plane 40 may not communicate directly with network control plane 30. Rather, the provision of network-wide SAN applications 36 may be through switch control plane 32 or line card control plane 34, which may communicate with network-wide control plane 30 to facilitate the provision of network-wide SAN applications 36.

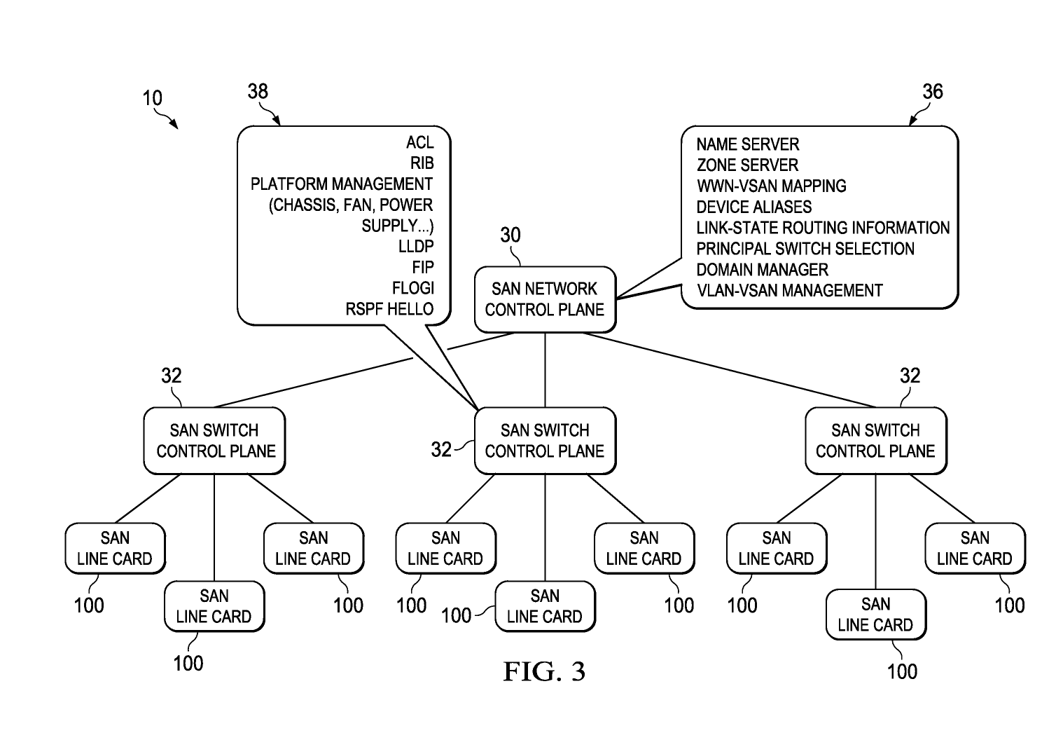

Turning to FIG. 3, FIG. 3 is a simplified block diagram illustrating example details of an embodiment of communication system 10. A single network control plane 30 may communicate with a plurality of switch control plane(s) 32, each of which may communicate with a plurality of SAN line card(s) 100. Centralized network-wide SAN applications 36 may be configured at network control plane 30. In the example embodiment illustrated in the figure, substantially all switch-level SAN applications 38 may be configured at switch control plane(s) 32.

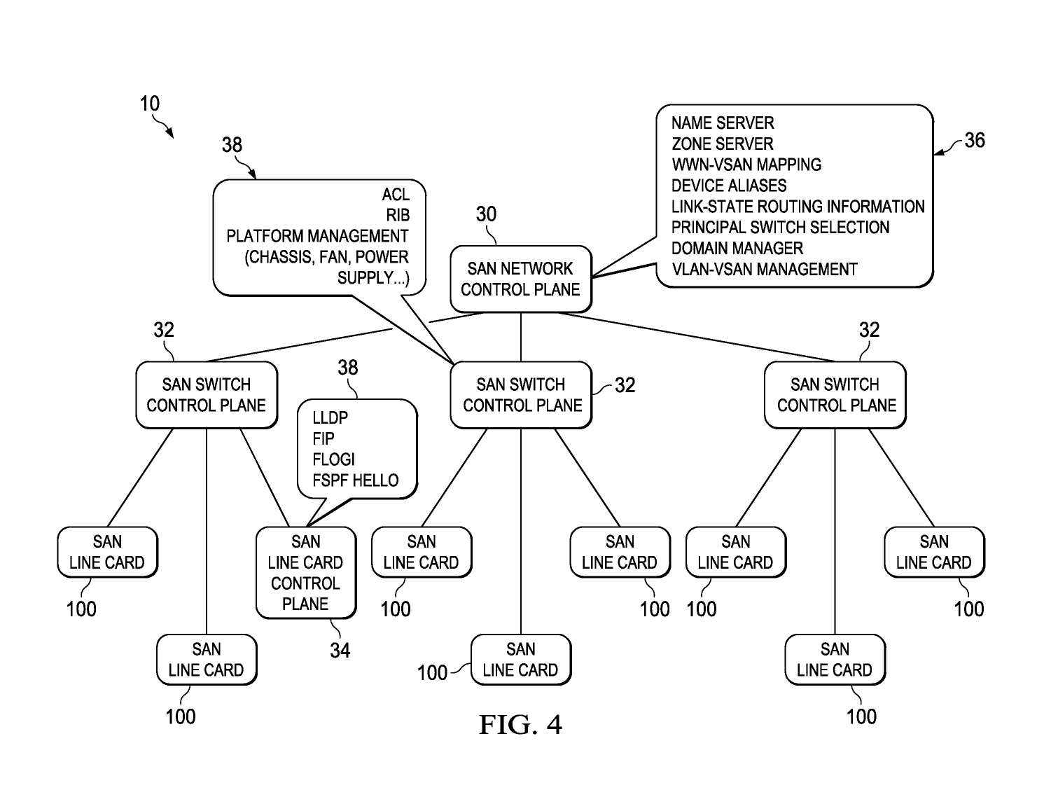

Turning to FIG. 4, FIG. 4 is a simplified block diagram illustrating example details of an embodiment of communication system 10. A single network control plane 30 may communicate with a plurality of switch control plane(s) 32, each of which may communicate with a plurality of SAN line card(s) 100. Some or each of SAN line cards 100 may be configured with SAN line card control plane 34. Centralized network-wide SAN applications 36 may be configured at network control plane 30. In the example embodiment illustrated in the figure, some switch-level SAN applications 38 (e.g., ACL 84, RIB 86, platform management 83) may be configured at switch control plane(s) 32, and some other switch-level SAN applications 38 (e.g., LLDP 92, FIP 94, FLOGI 96 and FSPF Hello 88, etc.) may be configured at line card control plane 34.

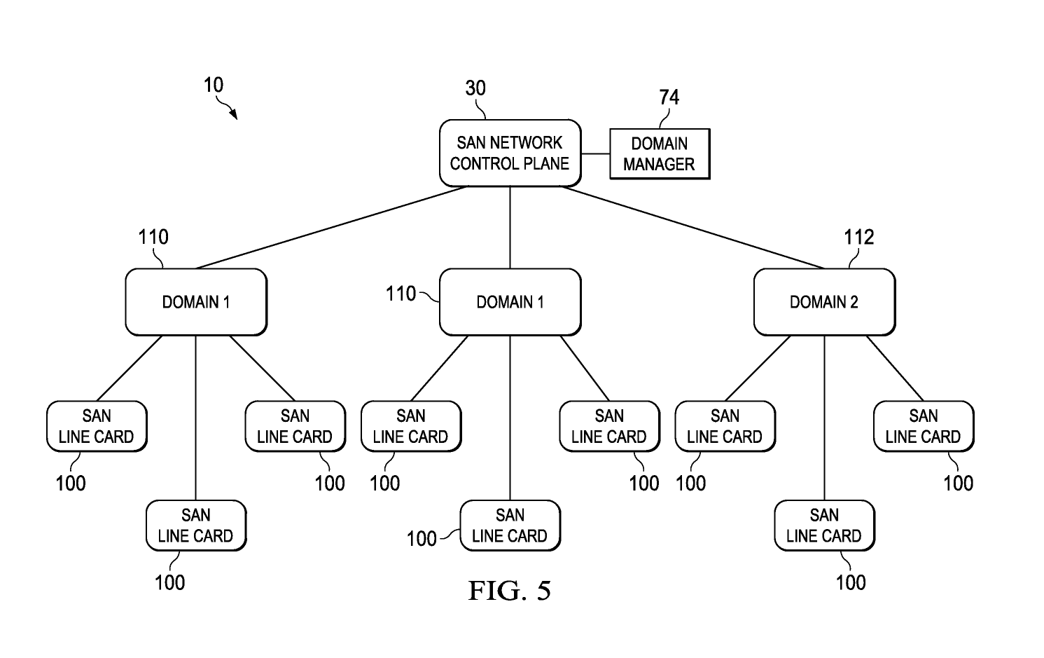

Turning to FIG. 5, FIG. 5 is a simplified block diagram illustrating example configurations of domains in SAN 12. According to an example embodiment, domains 110 and 112 may be configured at a switch-level. Multiple switches may share the same domain; each switch may belong to at most one domain; and each line card 100 may belong to a single domain. Domain manager 74 configured in network control plane 30 can assign a unique domain ID per switch. Each server or storage device logging into the switch may be assigned an address including the domain ID of the switch. Although only two domains are illustrated in the figure, it can be understood that any number of domains may be configured at the switch level within the broad scope of the embodiments.

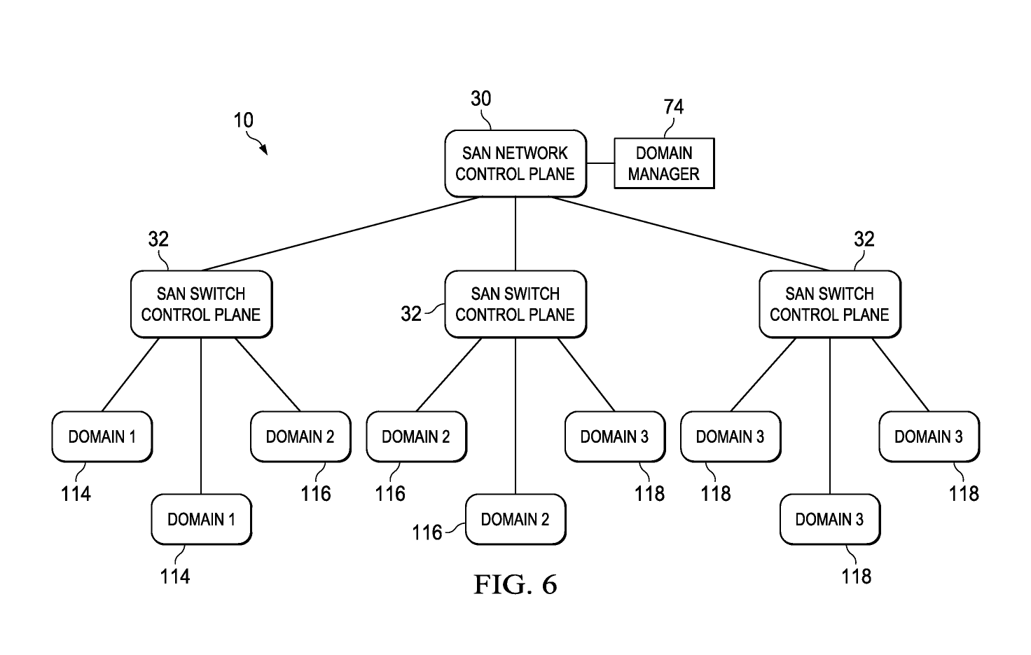

Turning to FIG. 6, FIG. 6 is a simplified block diagram illustrating example configurations of domains in SAN 12. According to an example embodiment, domains 114-118 may be configured at a line card-level. Multiple switches may share the same domain; each switch can belong to multiple domains; and each line card may belong to a single domain. Domain manager 74 configured in network control plane 30 can assign a unique domain ID per line card. Each server or storage device logging into the line card may be assigned an address including the domain ID of the line card. Although only three domains are illustrated in the figure, it can be understood that any number of domains may be configured at the switch level within the broad scope of the embodiments.

Note that a single domain can include over 65,000 servers and storage devices. If a switch supports 480 ports (e.g., 10 line cards of 48 ports each), up to 135 switches may be managed as part of a single domain, reducing a total number of domain-IDs by a factor of 135. Flexible domain assignments can also be used to separate FCoE and FC devices into separate domains; to separate tenants of a virtualized SAN network into separate domains; or to separate applications according to different domain-IDs.

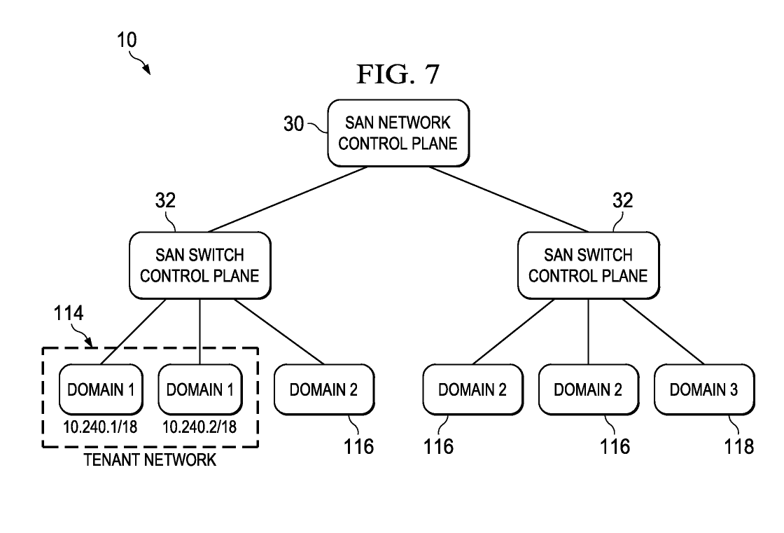

Turning to FIG. 7, FIG. 7 is a simplified block diagram illustrating an example domain ID assignment according to an embodiment of communication system 10. For route optimization purposes, each switch or line card can be assigned a contiguous set of domain-IDs. For example, a switch may be assigned a domain-ID range indicated as 10.240.0/15, facilitating up to 512 (2⁹) servers or storage devices to be connected to the switch. In the example illustrated in the figure, line cards 100 at domain 114 may be given a domain-ID range of 10.240.0/18 allowing 64 (2⁶) servers or storage devices to login into the line card.

A forwarding information base (FIB) table on line card 100 may be configured with a specific route. According to various embodiments, an entry in the FIB table corresponding to the route may include a first 15 bits representing a “network part” of an Fibre Channel ID (FC-ID) of the end point (e.g., server or storage device) of the route, and a last 9 bits representing a “host” part, which can identify a specific server or storage device that is the end point of the route. The address masking scheme can permit flexible address assignments, and allow for larger SANs with a fewer number of domains.

When SAN 12 is virtualized for different tenants, specific address masks may be assigned to respective tenants. Routes to a particular tenant's specific addresses may be installed on line cards that participate in the corresponding tenant's traffic. No other line card may be configured with any of the tenant specific routes, whereby, each line card can reduce the number of routes installed in the FIB table.

Domain ID masking in a multi-tenant environment can help reduce FIB entries, because different tenants need not see each other's devices and routes. Masking can increase address space utilization, for example, because more servers and storage devices may be configured in a single domain. The masking technique can be extended to VSANs also within the broad scope of the embodiments. The combination of domain-ID masking and VSANs can increase a total number of possible network segments in SAN 12 without substantially increasing the FIB tables (or entries thereof).

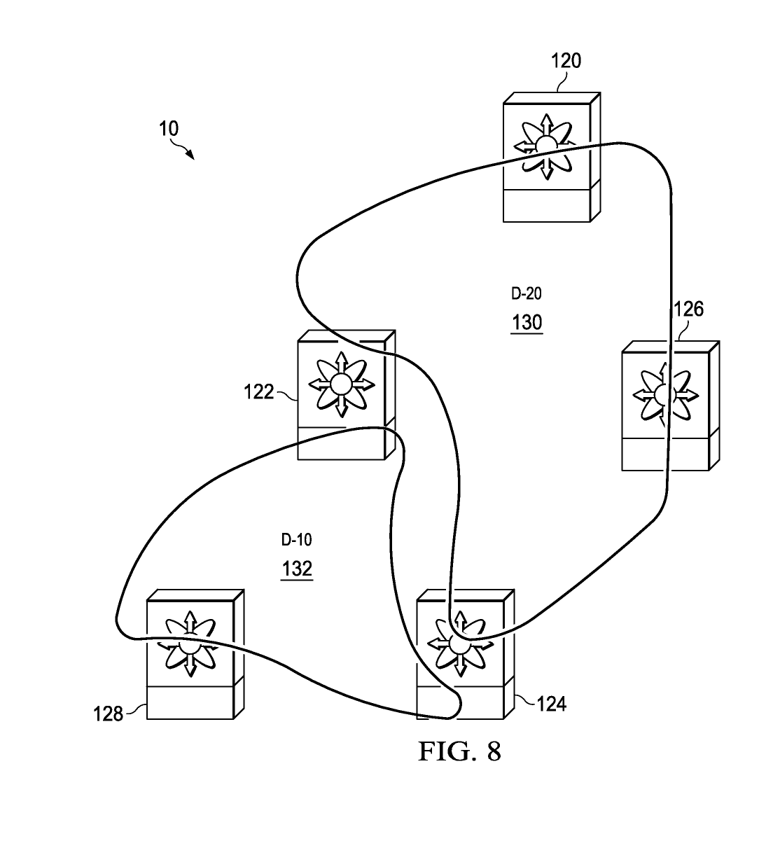

Turning to FIG. 8, FIG. 8 is a simplified block diagram illustrating example domain configurations according to an embodiment of communication system 10. In particular embodiments, a domain can span across multiple physical switches thereby conserving Domain IDs. For example, switches 120-128 may be included in SAN 12. Switches 120-126 may be included in domain 130 (D-20) and switches 122, 124 and 128 may be included in another domain 132 (D-10). Reduction of Domain IDs can simplify management of SAN, for example, because the management complexity generally increases with increase in Domain IDs. With a Domain ID spanning multiple switches, a logical switch can connect over 65,000 hosts per logical switch.

Also, as a server or storage device is moved from one location (e.g., connected to a specific physical switch A) to another location (e.g., connection another specific physical switch B), the FC-IDs can be preserved, thereby avoiding reconfiguring of zoning and other security information. Thus, servers and storage devices can be moved without reconfiguring the network. The moving server or storage device can be identified by a port world-wide name PWWN in some embodiments. In other embodiments, for example, FCoE SANs, moving server, or storage device can be identified by a Converged Network Adapter (CNA) MAC address and assigned the FC-ID.

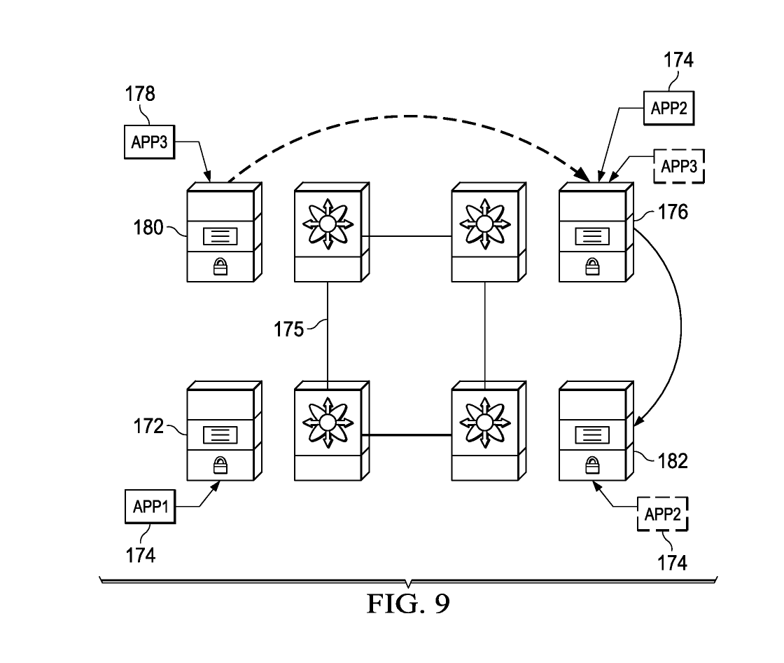

Turning to FIG. 9, FIG. 9 represents a specific application of a centralized control plane according to an embodiment of communication system 10. Central controller 16 can provide global “flow” path visualization. For example, flow statistics monitored at central controller 16 may interface end-to-end flows (and not merely counters). Flow visualization can provide improved network optimization tools, for example, to locate VMs for optimized flows for a specific flow pattern. Moreover, central controller 16 can be configured with distinct service level agreements (SLAs) for different tenants, with corresponding flow controls and other network parameters suitably configured for the respective tenants.

Central controller 16 can optimize network bandwidth, for example, so that elephant flows that consume a relatively higher bandwidth are confined to smaller scale networks, and mouse flow that consume a relatively smaller bandwidth are implemented on a larger scale network. In an example, assume an application 170 on server 172 sends a large amount of packets to a remote target application 174 on server 176. Application 170 may also send a smaller amount of packets to a nearby target application 178 on server 180. A larger amount of bandwidth may be consumed by the traffic flow between application 170 and 174 compared to the traffic flow between application 170 and 178. To conserve bandwidth, central controller 16 may cause application 174 to be moved from server 176 to server 182 and application 178 to be moved from server 180 to server 176. Consequently, the larger haul network between server 172 and 176 may see a smaller flow (e.g., mouse flow) and the smaller haul network between server 172 and 182 may see a larger flow (e.g., elephant flow).

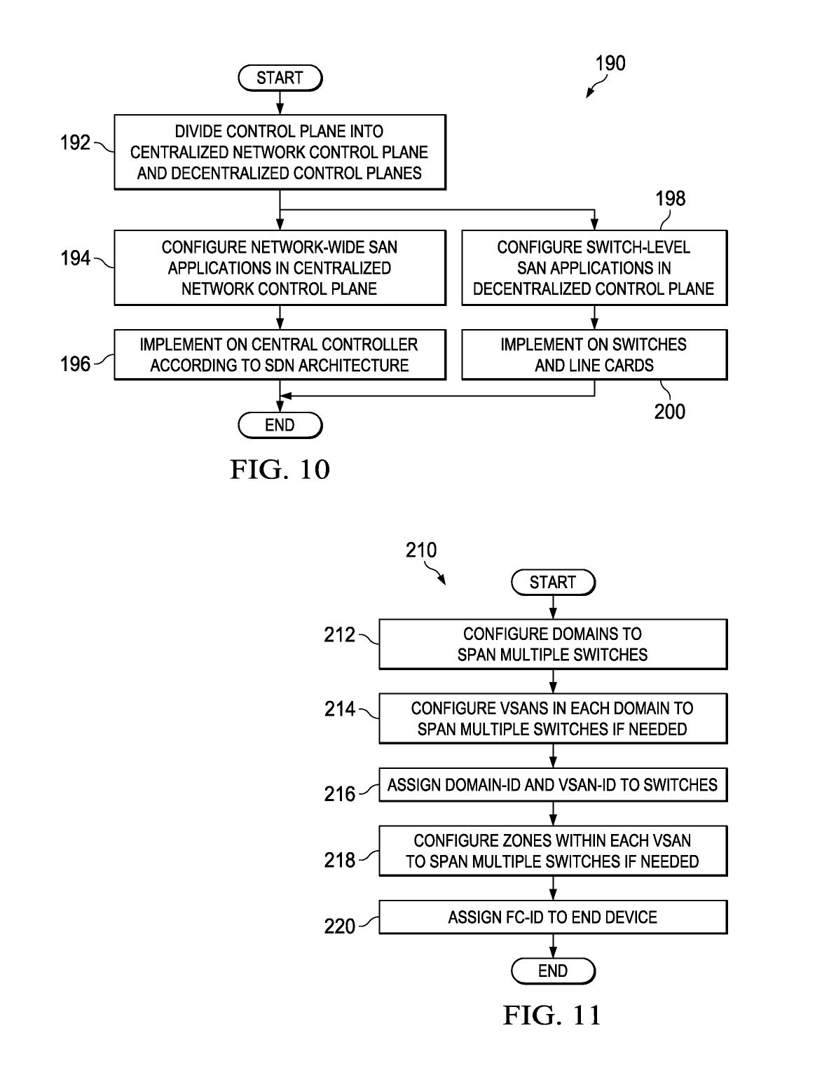

Turning to FIG. 10, FIG. 10 is a simplified flow diagram illustrating example operations 190 according to an embodiment of communication system 10. At 192, the control plane in SAN 12 may be divided into centralized network control plane 30 and decentralized control planes (e.g., switch control plane 32 and line card control plane 34). At 194, network-wide SAN applications 36 may be configured in network control plane 30. At 196, network control plane 30 may be implemented on central controller 16 according to SDN architecture. At 198, switch-level SAN applications 38 may be configured on the decentralized control planes. At 200, the decentralized control planes may be implemented on switches and line cards in SAN 12.

Turning to FIG. 11, FIG. 11 is a simplified flow diagram illustrating example operations 210 that may be associated with an embodiment of communication system 10. At 212, domains may be configured in SAN 12 to span multiple switches. At 214, VSANs may be configured in each domain to span multiple switches (if needed). At 216, respective domain IDs may be assigned to the domains, and respective VSAN IDs may be assigned to the VSANs. At 218, zones may be configured in each VSAN to span multiple switches (if needed). At 220, a unique FC-ID may be assigned to an end device (e.g., application, server, or storage device) in SAN 12 during login.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Note also that an ‘application’ as used herein this Specification, can be inclusive of an executable file comprising instructions that can be understood and processed on a computer, and may further include library modules loaded during execution, object files, system files, hardware logic, software logic, or any other executable modules.

In example implementations, at least some portions of the activities outlined herein may be implemented in software in, for example, central controller 16. In some embodiments, one or more of these features may be implemented in hardware, provided external to these elements, or consolidated in any appropriate manner to achieve the intended functionality. The various network elements may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, central controller 16 described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory elements 44, 54, 62) can store data used for the operations described herein. This includes the memory element being able to store instructions (e.g., software, logic, code, etc.) in non-transitory computer readable media, such that the instructions are executed to carry out the activities described in this Specification. A processor can execute any type of instructions associated with the data to achieve the operations detailed herein in this Specification. In one example, processors (e.g., processors 42, 52, 60) could transform an element or an article (e.g., data) from one state or thing to another state or thing.

In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory computer readable storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in communication system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, communication system 10 may be applicable to other exchanges or routing protocols. Moreover, although communication system 10 has been illustrated with reference to particular elements and operations that facilitate the communication process, these elements, and operations may be replaced by any suitable architecture or process that achieves the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
dividing a control plane of a storage area network (SAN) into a centralized network control plane and a plurality of decentralized control planes;
configuring at least one network-wide SAN application in the centralized network control plane; and
configuring at least one switch-level SAN application in the decentralized control planes.

2. The method of claim 1, wherein the centralized network control plane is implemented on a central controller according to software defined networking (SDN) architecture.

3. The method of claim 1, wherein the at least one network-wide SAN application includes a selection from a group consisting of: name server, zone server, world wide name (WWN)-virtual SAN (VSAN) mapping, device aliases, link-state routing information, principal switch selection, domain manager, and virtual local area network (VLAN)-VSAN mapping.

4. The method of claim 1, wherein the decentralized control planes include switch control planes, wherein the at least one switch-level SAN application includes a selection from a group consisting of: Link Layer Discovery Protocol (LLDP), Cisco Discovery Protocol (CDP), Fabric Channel over Ethernet Initialization Protocol (FIP), Fabric login (FLOGI), Access Control Lists (ACLS), platform management, routing information base (RIB), and Fabric Shortest Path First (FSPF) Hello.

5. The method of claim 1, wherein the decentralized control planes include switch control planes and line card control planes, wherein the at least one switch-level SAN application configured at the switch control planes includes a selection from a group consisting of: ACLs, RIB and platform management, wherein the at least one switch-level SAN application configured at the line card control planes includes a selection from a group consisting of: LLDP, CDP, FIP, FLOGI, and FSPF Hello.

6. The method of claim 1, wherein the SAN includes a plurality of domains, wherein each domain spans a plurality of switches, wherein each switch belongs to at most one domain, and wherein a domain identifier (ID) is assigned to each switch.

7. The method of claim 1, wherein the SAN includes a plurality of domains, wherein each domain spans a plurality of switches, wherein each switch belongs to more than one domain, wherein the SAN includes a plurality of line cards, wherein a domain ID is assigned to each line card.

8. The method of claim 7, wherein a contiguous set of domain IDs are assigned to line cards in a single domain.

9. One or more non-transitory tangible media that includes instructions for execution, which when executed by a processor, is operable to perform operations comprising:
dividing a control plane of a SAN into a centralized network control plane and a plurality of decentralized control planes;
configuring at least one network-wide SAN application in the centralized network control plane; and
configuring at least one switch-level SAN application in the decentralized control planes.

10. The media of claim 9, wherein the at least one network-wide SAN application includes a selection from a group consisting of: name server, zone server, WWN-VSAN mapping, device aliases, link-state routing information, principal switch selection, domain manager, and VLAN-VSAN mapping.

11. The media of claim 9, wherein the decentralized control planes include switch control planes, wherein the at least one switch-level SAN application includes a selection from a group consisting of: LLDP, CDP, FIP, FLOGI, ACLs, platform management, RIB, and FSPF Hello.

12. The media of claim 9, wherein the decentralized control planes include switch control planes and line card control planes, wherein the at least one switch-level SAN application configured at the switch control planes includes a selection from a group consisting of: ACLs, RIB and platform management, wherein at least one the switch-level SAN application configured at the line card control planes includes a selection from a group consisting of: LLDP, CDP, FIP, FLOGI, and FSPF Hello.

13. The media of claim 9, wherein the SAN includes a plurality of domains, wherein each domain spans a plurality of switches, wherein each switch belongs to at most one domain, and wherein a domain identifier (ID) is assigned to each switch.

14. The media of claim 9, wherein the SAN includes a plurality of domains, wherein each domain spans a plurality of switches, wherein each switch belongs to more than one domain, wherein the SAN includes a plurality of line cards, wherein a domain ID is assigned to each line card.

15. An apparatus, comprising:
a memory element for storing data; and
a processor that executes instructions associated with the data, wherein the processor and the memory element cooperate such that the apparatus is configured for:
dividing a control plane of a SAN into a centralized network control plane and a plurality of decentralized control planes;
configuring at least one network-wide SAN application in the centralized network control plane; and
configuring at least one switch-level SAN application in the decentralized control planes.

16. The apparatus of claim 15, wherein the at least one network-wide SAN application includes a selection from a group consisting of: name server, zone server, WWN-VSAN mapping, device aliases, link-state routing information, principal switch selection, domain manager, and VLAN-VSAN mapping.

17. The apparatus of claim 15, wherein the decentralized control planes include switch control planes, wherein the at least one switch-level SAN application include a selection from a group consisting of: LLDP, CDP, FIP, FLOGI, ACLs, platform management, RIB, and FSPF Hello.

18. The apparatus of claim 15, wherein the decentralized control planes include switch control planes and line card control planes, wherein the at least one switch-level SAN application configured at the switch control planes includes a selection from a group consisting of: ACLs, RIB and platform management, wherein the at least one switch-level SAN application configured at the line card control planes includes a selection from a group consisting of: LLDP, CDP, FIP, FLOGI, and FSPF Hello.

19. The apparatus of claim 15, wherein the SAN includes a plurality of domains, wherein each domain spans a plurality of switches, wherein each switch belongs to at most one domain, and wherein a domain identifier (ID) is assigned to each switch.

20. The apparatus of claim 15, wherein the SAN includes a plurality of domains, wherein each domain spans a plurality of switches, wherein each switch belongs to more than one domain, wherein the SAN includes a plurality of line cards, wherein a domain ID is assigned to each line card.
